(19) United States
(12) Patent Application Publication
(10) Pub. No.: US 2026/0147806 A1
(43) Pub. Date: May 28, 2026

(54) SYSTEM, METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Keiko NAKANO, Kawasaki-shi (JP); Yuya KANEHANA, Nagakute-shi (JP)

(73) Assignee: TOYOTA JIDOSHA KABUSHIKI KAISHA, Toyota-shi (JP)

(21) Appl. No.: 19/374,322

(22) Filed: Oct. 30, 2025

(30) Foreign Application Priority Data
Nov. 22, 2024 (JP) 2024-204276

(51) Int. Cl. G06F 16/334; G06F 16/3329

(52) U.S. Cl. CPC G06F 16/334; G06F 16/33295

(57) ABSTRACT

A system includes a communication apparatus and a server. The server stores a first dialogue model and a second dialogue model. The communication apparatus displays a first screen on which dialogue between a user and the first dialog model is performed, and transmits, to the server, question text inputted on the first screen by the user. The server determines whether predicted time required for the first dialogue model to generate an answer to a question content according to the question text is long relative to a predetermined reference. When it is determined by the server that the predicted time is long relative to the predetermined reference, the server performs dialogue between the user and the second dialog model until the first dialogue model completes generating the answer.

### CROSS-REFERENCE TO RELATED APPLICATION

This application claims priority to Japanese Patent Application No. 2024-204276 filed on November 22, 2024, the entire contents of which are incorporated herein by reference.

### TECHNICAL FIELD

The present disclosure relates to a system, a method, and a program.

### BACKGROUND

Technology of AI chatbots including multiple dialogue models is known. For example, Patent Literature (PTL) 1 discloses technology of an AI chatbot including multiple dialogue models, that selects a dialogue model according to a question content of a user and dialogues with the user.

### CITATION LIST

### Patent Literature

PTL 1: JP 2020-091513 A

### SUMMARY

There is room for improvement in technology of AI chatbots including multiple dialogue models.

It would be helpful to improve technology of AI chatbots including multiple dialogue models.

A system according to an embodiment of the present disclosure is a system including:

a communication apparatus; and

a server,

wherein

the server is configured to store a first dialogue model and a second dialogue model,

the communication apparatus is configured to:

display a first screen on which dialogue between a user and the first dialogue model is performed; and

transmit, to the server, question text inputted on the first screen by the user, and

the server is configured to:

determine whether predicted time required for the first dialogue model to generate an answer to a question content according to the question text is long relative to a predetermined reference; and

when the predicted time is determined to be long relative to the predetermined reference, perform dialogue between the user and the second dialogue model until the first dialogue model completes generating the answer.

A method according to an embodiment of the present disclosure is a method performed by a system including a communication apparatus and a server, the method including:

storing, by the server, a first dialogue model and a second dialogue model;

displaying, by the communication apparatus, a first screen on which dialogue between a user and the first dialogue model is performed;

transmitting, by the communication apparatus to the server, question text inputted on the first screen by the user;

determining, by the server, whether predicted time required for the first dialogue model to generate an answer to a question content according to the question text is long relative to a predetermined reference; and

when the predicted time is determined to be long relative to the predetermined reference, performing, by the server, dialogue between the user and the second dialogue model until the first dialogue model completes generating the answer.

A program according to an embodiment of the present disclosure is configured to cause a system including a communication apparatus and a server to execute operations, the operations including:

storing, by the server, a first dialogue model and a second dialogue model;

displaying, by the communication apparatus, a first screen on which dialogue between a user and the first dialogue model is performed;

transmitting, by the communication apparatus to the server, question text inputted on the first screen by the user;

determining, by the server, whether predicted time required for the first dialogue model to generate an answer to a question content according to the

question text is long relative to a predetermined reference; and

when the predicted time is determined to be long relative to the predetermined reference, performing, by the server, dialogue between the user and the second dialogue model until the first dialogue model completes generating the answer.

According to an embodiment of the present disclosure, technology of AI chatbots including multiple dialogue models is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a flowchart illustrating operations of a server;

FIG. 3 is a flowchart illustrating operations of a communication apparatus;

FIG. 4 is a diagram illustrating an example of a dialogue screen with a first dialogue model;

FIG. 5 is a diagram illustrating an example of overlaying a dialogue screen with a second dialogue model on the dialogue screen with the first dialogue model;

FIG. 6 is a diagram illustrating an example in which dialogue with the second dialogue model and question contents are displayed on the dialogue screen with the first dialogue model; and

FIG. 7 is a diagram illustrating an example in which dialogue with the first dialogue model and dialogue with the second dialogue model are displayed in a distinguishable manner.

### DETAILED DESCRIPTION

Hereinafter, an embodiment of the present disclosure will be described.

### Outline of Embodiment

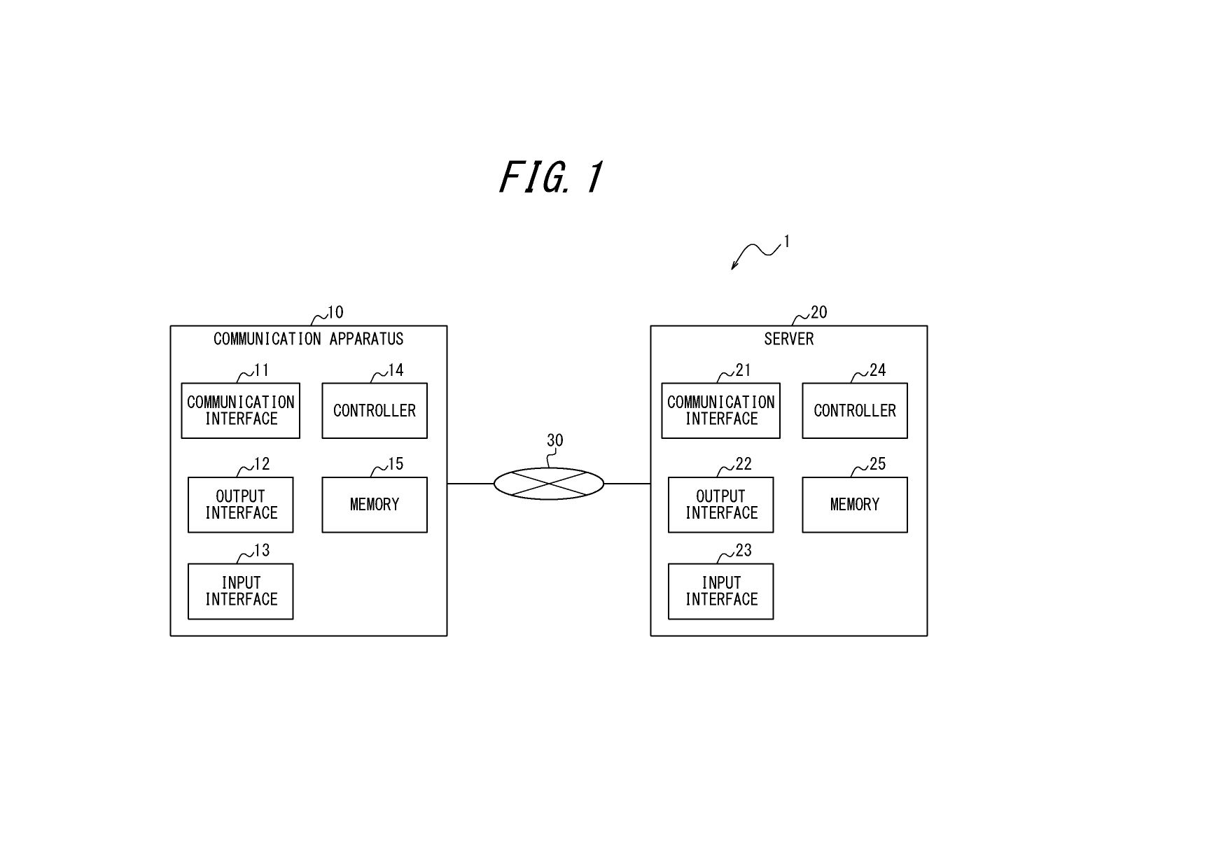

An outline of a system 1 according to the embodiment of the present disclosure will be described with reference to FIG. 1. The system 1 includes a communication apparatus 10 and a server 20. By operating the communication apparatus 10, a user can perform dialogue with an AI chatbot stored in the server 20. Upon determining that it takes time to generate an answer to a question of the user, the server 20 performs dialogue with a different AI chatbot from the AI chatbot that is generating the answer until the AI chatbot completes generating the answer. The communication apparatus 10 and the server 20 are communicably connected to a network 30 including, for example, the Internet and a mobile communication network.

The communication apparatus 10 is, for example, a computer, a smartphone, or a navigation apparatus mounted in a vehicle, but may also be any communication apparatus not limited to these. The number of communication apparatuses 10 included in the system 1 may be freely determined.

The server 20 is a computer or multiple computers that can communicate with each other, and can communicate with the communication apparatus 10 via the network 30.

First, an outline of the present embodiment will be described, and details thereof will be described later. The system 1 includes the communication apparatus 10 and the server 20. The server 20 stores a first dialogue model and a second dialogue model. The communication apparatus 10 displays a first screen 40 on which dialogue between a user and the first dialogue model is performed, and transmits, to the server 20, question text inputted on the first screen 40 by the user. The server 20 determines whether predicted time required for the first dialogue model to generate an answer to a question content according to the question text is long relative to a predetermined reference. When it is determined by the server 20 that the predicted time is long relative to the predetermined reference, the server 20 performs dialogue between the user and the second dialog model until the first dialogue model completes generating the answer.

Thus, according to the present embodiment, when predicted time required to generate an answer to a question from a user is determined to be long relative to a predetermined reference, the server 20 performs dialogue between the user and the second dialogue model until the first dialogue model completes generating the answer. This allows the user to perceive time for the first dialogue model to generate the answer as shorter. By performing the dialogue with the second dialogue model, the user can recognize that the system 1 is operating normally. Therefore, technology of AI chatbots including multiple dialogue models is improved in terms of reducing the perceived time of the user and allowing the user to recognize that the system 1 is operating normally.

Next, configurations of the system 1 will be described in detail.

### Configuration of Communication Apparatus 10

As illustrated in FIG. 1, the communication apparatus 10 includes a communication interface 11, an output interface 12, an input interface 13, a controller 14, and a memory 15.

The communication interface 11 includes at least one communication interface for connecting to the network 30. The communication interface is compliant with a mobile communication standard such as the 4th generation (4G) standard or the 5th generation (5G) standard, for example, but is not limited to these. In the present embodiment, the communication apparatus 10 communicates with the server 20 via the communication interface 11 and the network 30.

The output interface 12 includes at least one output device for outputting information. The output device is, for example, a display, a speaker, or the like, but is not limited to these. Alternatively, the output interface 12 may include an interface for connecting to an external output device.

The input interface 13 includes at least one input device for detecting user input. The input device is, for example, a physical key, a capacitive key, a pointing device such as a mouse, a touch screen integrally provided with a display of the output interface 12, a microphone for accepting audio input, or the like, but is not limited to these. Alternatively, the input interface 13 may include an input interface for detecting user input via an external input device.

The controller 14 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 14 controls operations of the entire communication apparatus 10.

The memory 15 includes one or more memories. The memories are, for example, semiconductor memories, magnetic memories, optical memories, or the like, but are not limited to these. The memories included in the memory 15 may each function as, for example, a main memory, an auxiliary memory, or a cache memory. The memory 15 stores any information to be used for operations of the communication apparatus 10. For example, the memory 15 may store a system program, an application program, embedded software, and the like. The information stored in the memory 15 may be updated with, for example, information acquired from the network 30 via the communication interface 11.

### Configuration of Server 20

As illustrated in FIG. 1, the server 20 includes a communication interface 21, an output interface 22, an input interface 23, a controller 24, and a memory 25.

The communication interface 21 includes at least one communication interface for connecting to the network 30. The communication interface is compliant with a mobile communication standard such as the 4th generation (4G) standard or the 5th generation (5G) standard, for example, but is not limited to these. In the present embodiment, the server 20 communicates with the communication apparatus 10 via the communication interface 21 and the network 30.

The output interface 22 includes at least one output device for outputting information. The output device is, for example, a display, a speaker, or the like, but is not limited to these. Alternatively, the output interface 22 may include an interface for connecting to an external output device.

The input interface 23 includes at least one input device for detecting user input. The input device is, for example, a physical key, a capacitive key, a pointing device such as a mouse, a touch screen integrally provided with a display of the output interface 22, a microphone for accepting audio input, or the like, but is not limited to these. Alternatively, the input interface 23 may include an input interface for detecting user input via an external input device.

The controller 24 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 24 controls operations of the entire server 20.

The memory 25 includes one or more memories. The memories are, for example, semiconductor memories, magnetic memories, optical memories, or the like, but are not limited to these. The memories included in the memory 25 may each function as, for example, a main memory, an auxiliary memory, or a cache memory. The memory 25 stores any information to be used for operations of the server 20. For example, the memory 25 may store a system program, an application program, embedded software, or the like. The memory 25 may also store an AI chatbot that includes a first dialogue model and a second dialogue model. The first dialogue model is a model that generates and outputs an answer to a question content of a user. The second dialogue model is a model that performs dialogue with the user until the first dialogue model completes generating the answer. The second dialogue model is a model that requires less time to generate dialogue, compared to the first dialogue model.

### Operation Flow of Server 20

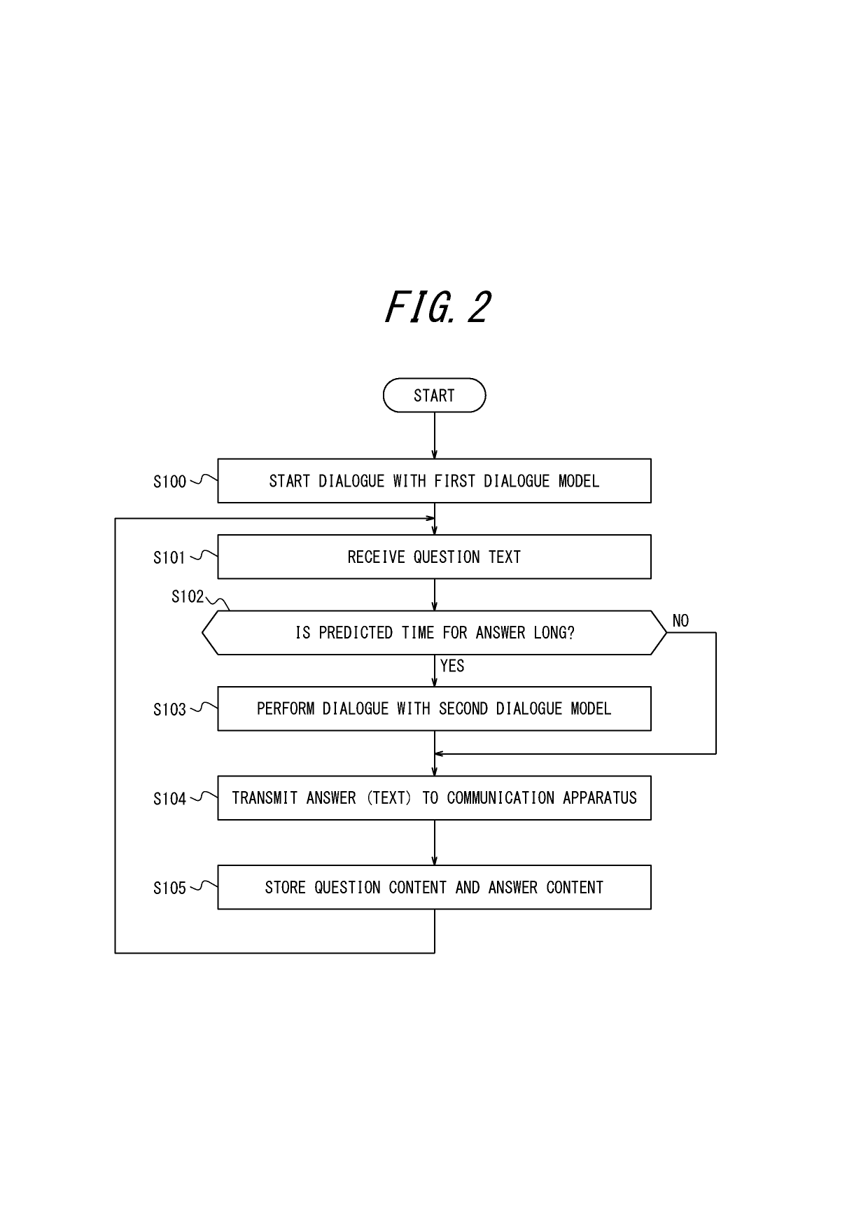

With reference to FIG. 2, operations of the server 20 according to the present embodiment will be described.

S100: The controller 24 starts dialogue with the first dialogue model stored in the memory 25.

The dialogue with the first dialogue model may be started when the server 20 has received information indicating that a user has operated the communication apparatus 10 and has started dialogue with the first dialogue model, but any start condition not limited to this may be determined.

S101: The input interface 23 receives, via the network 30, question text inputted on the input interface 13 by the user.

The question text is a sentence inputted on the input interface 13 by the user. Any method can be employed for inputting.

S102: The controller 24 determines whether predicted time required for the first dialogue model to generate an answer to a question content according to the question text is long relative to a predetermined reference.

The question content is extracted from the question text inputted by the user. Any method can be employed for extracting information, including query transformation such as natural language processing. The predicted time may be determined to be short relative to the predetermined reference when, for example, the question content according to the question text inputted by the user is included in historical information described later. When the question content according to the question text inputted by the user is not included in the historical information, the predicted time may be determined to be long relative to the predetermined reference. When the predicted time is determined to be long relative to the predetermined reference, S103 is executed. When the predicted time is determined to be short relative to the predetermined reference, S104 is executed.

S103: The controller 24 performs dialogue between the user and the second dialogue model until the first dialogue model completes generating the answer.

When the predicted time is determined to be long relative to the predetermined reference, the controller 24 performs dialogue with the second dialogue model on the communication apparatus 10 operated by the user via the network 30, until the first dialogue model completes generating the answer. This allows the user to perceive time for the first dialogue model to generate the answer as shorter. By performing the dialogue with the second dialogue model, the user can recognize that the system 1 is operating normally.

S104: The controller 24 transmits, via the network 30 to the communication apparatus 10, the answer (text) generated by the first dialogue model.

For example, the controller 24 transmits the answer text to the communication apparatus 10. The controller 24 may transmit information regarding the answer, and cause the communication apparatus 10 to generate answer text.

S105: The controller 24 stores, in the memory 25, the question content and an answer content to the question content.

The memory 25 stores the historical information that includes one or more past inputted question contents and one or more answer contents to the one or more question contents. When the question content according to the question text inputted by the user is included in the historical information in the memory 25, the controller 24 may determine that the predicted time is short. The controller 24 may also extract, using the first dialogue model, an answer content corresponding to the question content from the historical information, and generate an answer to the question content, based on the extracted answer content. This reduces waiting time of the user until the first dialogue model completes generating the answer.

### Operation Flow of Communication Apparatus 10

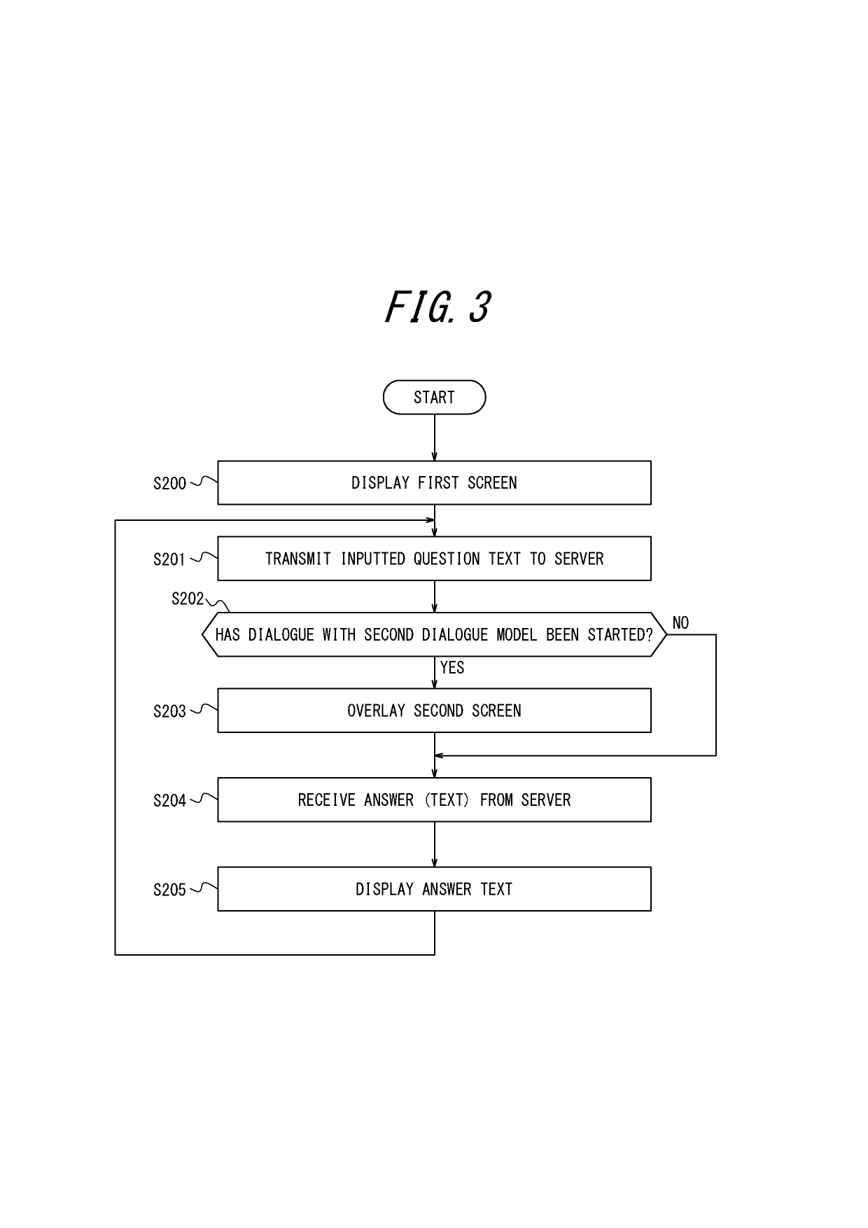

Operations of the communication apparatus 10 according to the present embodiment will be described with reference to FIG. 3.

S200: The controller 14 displays, on the output interface 12, a first screen 40 on which dialogue between the user and the first dialogue model is performed.

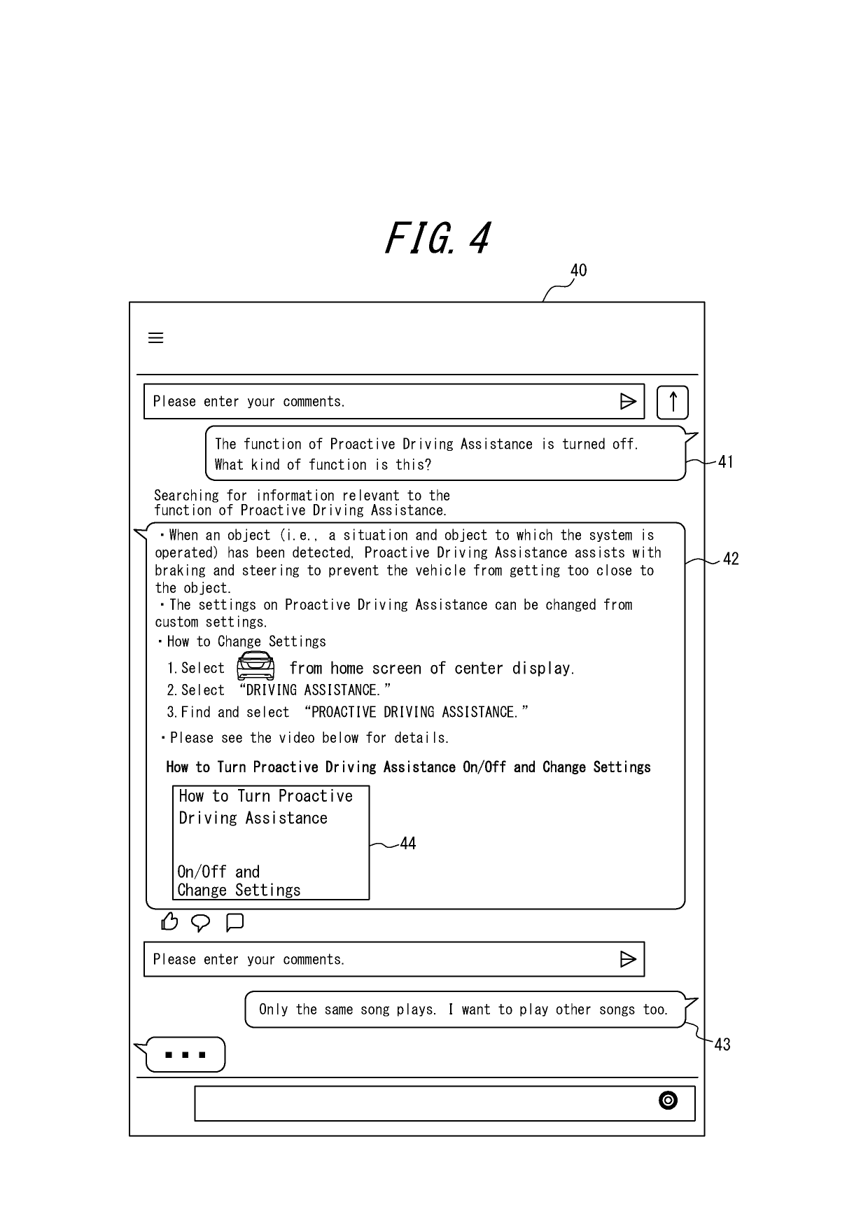

The first screen 40 is a screen to perform dialogue between the user and the first dialogue model. FIG. 4 is a diagram illustrating an example of the first screen 40. The first screen 40 includes a question 41 of the user, an answer 42 of the first dialogue model, and a question 43 of the user. The question 41 of the user is "The function of Proactive Driving Assistance is turned off. What kind of function is this?" The answer 42 of the first dialogue model is an explanation of the function regarding Proactive Driving Assistance and includes a video icon 44. When the video icon 44 is clicked, video plays. The question 43 of the user is "Only the same song plays. I want to play other songs too." The first screen 40 includes input interfaces for the user to input question text and displays to provide answers to questions of the user, but can display any information not limited to this.

S201: The controller 14 transmits, to the server 20, question text inputted on the first screen 40 by the user.

The user inputs question text to the input interface 13. The inputted question text is transmitted to the server 20 via the network 30. As the method of inputting the question text, any method such as text input or audio input can be employed.

S202: The controller 14 determines whether dialogue with the second dialogue model has been started.

The controller 14 determines whether the server 20 has determined to perform dialogue between the user and the second dialogue model. For example, the controller 14 may receive, from the server 20 via the network 30, information indicating that the dialogue with the second dialogue model has been started, but may perform determination by any method not limited to this. When the dialogue with the second dialogue model has been started by the server 20, S203 is executed. When the dialogue with the second dialogue model has not been started, S204 is executed.

S203: The controller 14 overlays, on the output interface 12, a second screen 50 on which the dialogue between the user and the second dialogue model is performed.

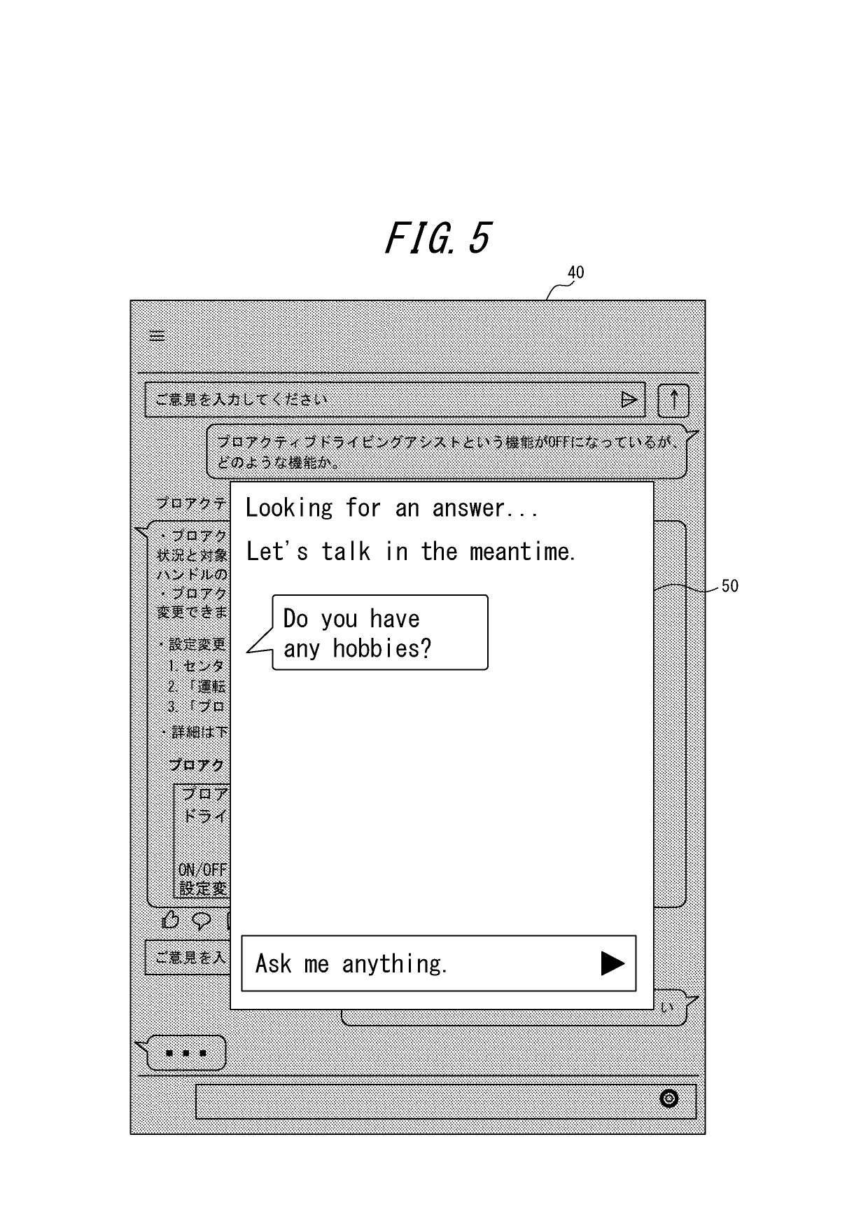

The second screen 50 is a screen to perform dialogue between the user and the second dialogue model. FIG. 5 illustrates an example of overlaying the second screen 50 on the first screen 40. The second screen 50 includes an input interface for the user to input question text and a display to provide an answer to a question of the user, but can display any information not limited to this. The second screen 50 can employ any display method, not limited to overlaying. This allows the user to recognize that the system 1 is operating normally. In the example of FIG. 5, on the second screen 50, dialogue unrelated to the question content that the user has asked the first dialogue model, such as "Do you have any hobbies?" is being performed on the second screen 50, but dialogue of any content, not limited to this, may be performed.

S204: The controller 14 receives, from the server 20 via the network 30, an answer (text) generated by the first dialogue model.

As the answer, for example, a sentence is received from the server 20. The controller 14 may receive information regarding the answer, and the communication apparatus 10 may generate a sentence.

S205: The controller 14 displays the answer text on the output interface 12.

Upon receiving the answer text from the server 20, for example, the controller 14 displays the received answer text on the output interface 12. Upon receiving the answer from the server 20, the controller 14 may generate answer text based on the answer, and display the answer text on the output interface 12. As the method of outputting the answer text, any method such as text display or audio output can be employed.

As described above, the system 1 includes the communication apparatus 10 and the server 20. The server 20 stores a first dialogue model and a second dialogue model. The communication apparatus 10 displays a first screen 40 on which dialogue between a user and the first dialogue model is performed, and transmits, to the server 20, question text inputted on the first screen 40 by the user. The server 20 determines whether predicted time required for the first dialogue model to generate an answer to a question content according to the question text is long relative to a predetermined reference. When it is determined by the server 20 that the predicted time is long relative to the predetermined reference, the server 20 performs dialogue between the user and the second dialog model until the first dialogue model completes generating the answer.

According to such a configuration, when the predicted time required to generate the answer to the question from the user is determined to be long relative to the predetermined reference, the server 20 performs the dialogue with the second dialogue model until the first dialogue model completes generating the answer. This allows the user to perceive time for the first dialogue model to generate the answer as shorter. By performing the dialogue with the second dialogue model, the user can recognize that the system 1 is operating normally. Therefore, technology of AI chatbots including multiple dialogue models is improved in terms of reducing the perceived time of the user and allowing the user to recognize that the system 1 is operating normally.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, an embodiment in which the configuration and operations of the server 20 in the above embodiment are distributed to multiple computers capable of communicating with each other can be implemented. For example, an embodiment in which some or all of the components of the server 20 are provided in the communication apparatus 10 can also be implemented.

For example, an embodiment in which the configuration and operations of the server 20 in the above embodiment are distributed to multiple computers capable of communicating with each other can be implemented. For example, an embodiment in which some or all of the components of the server 20 are provided in the communication apparatus 10 can also be implemented.

In the embodiment described above, the memory 25 may store a database containing materials regarding vehicles. The first dialogue model may be a model that uses Retrieval Augmented Generation (RAG), which refers to the database containing materials regarding vehicles when generating the answer to the question content of the user. The controller 24 may determine whether the predicted time is long relative to the predetermined reference, based on whether the first dialogue model needs to refer to the database, which contains materials regarding vehicles, stored in the memory 25 to generate the answer. Specifically, when it is determined by the server 20 that the first dialogue model does not need to refer to the database, the controller 24 determines that the predicted time is short. On the other hand, when it is determined by the server 20 that the first dialogue model needs to refer to the database, the controller 24 determines that the predicted time is long. The user can thereby perform dialogue with the second dialogue model, until the first dialogue model completes generating the answer using RAG, which can reduce the perceived time of the user and allow the user to recognize that the system 1 is operating normally.

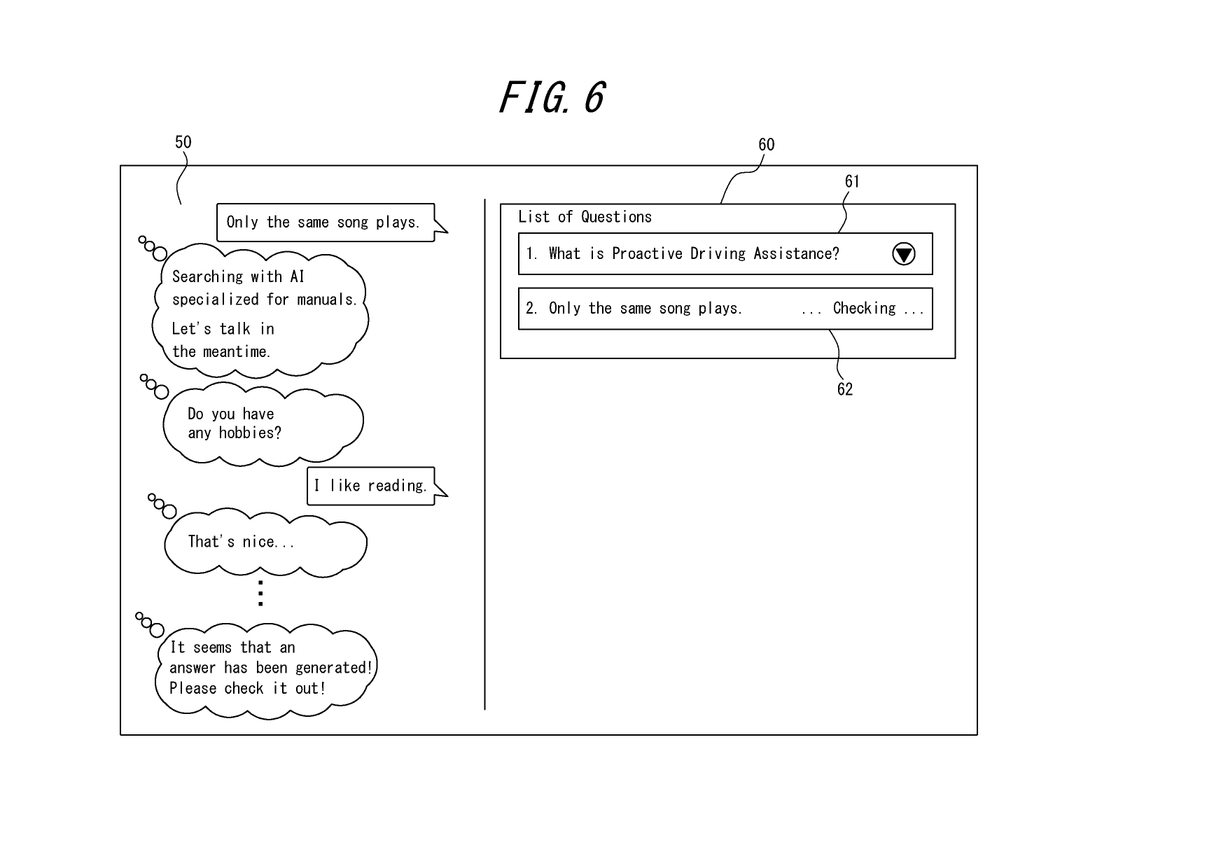

In the above embodiment, the server 20 may transmit the question content according to the question text to the communication apparatus 10. The communication apparatus 10 may display the question content on the output interface 12, until the communication apparatus 10 acquires, from the server 20, the answer to the question content. FIG. 6 is a diagram illustrating an example of a screen that includes the second screen 50 and a question list 60. The question list 60 includes a question 61 of the user and a question 62 of the user. The question 61 of the user is "What is Proactive Driving Assistance?" The question 62 of the user is "Only the same song plays." Here, the questions 41 and 43 of the user in FIG. 4 correspond to the questions 61 and 62 of the user in FIG. 6, respectively. The question 61 of the user has already been answered. By selecting the question 61 of the user, the answer 42 from the first dialogue model in FIG. 4 is displayed. In the second screen 50, dialogue between the user and the second dialogue model is being performed. This allows the user to instantly discover the question text. The user can also recognize that the system 1 is operating normally. In the example of FIG. 6, the question text inputted by the user "Only the same song plays." matches the question content "Only the same song plays." in the question list 60 for which the server 20 is generating an answer, but does not necessarily have to match. For example, the server 20 may perform query transformation including natural language processing, and transmit only information extracted from the question text to the communication apparatus 10. The communication apparatus 10 may display only the information extracted from the question text on the output interface 12. The communication apparatus 10 may display, on the output interface 12, question text generated by the server 20 based on the information extracted from the question text. At this time, the user can modify the question text as needed because the user can check whether an answer is being generated for a question the user intends to do so. This allows the user to reduce the time until acquiring an answer to the intended question.

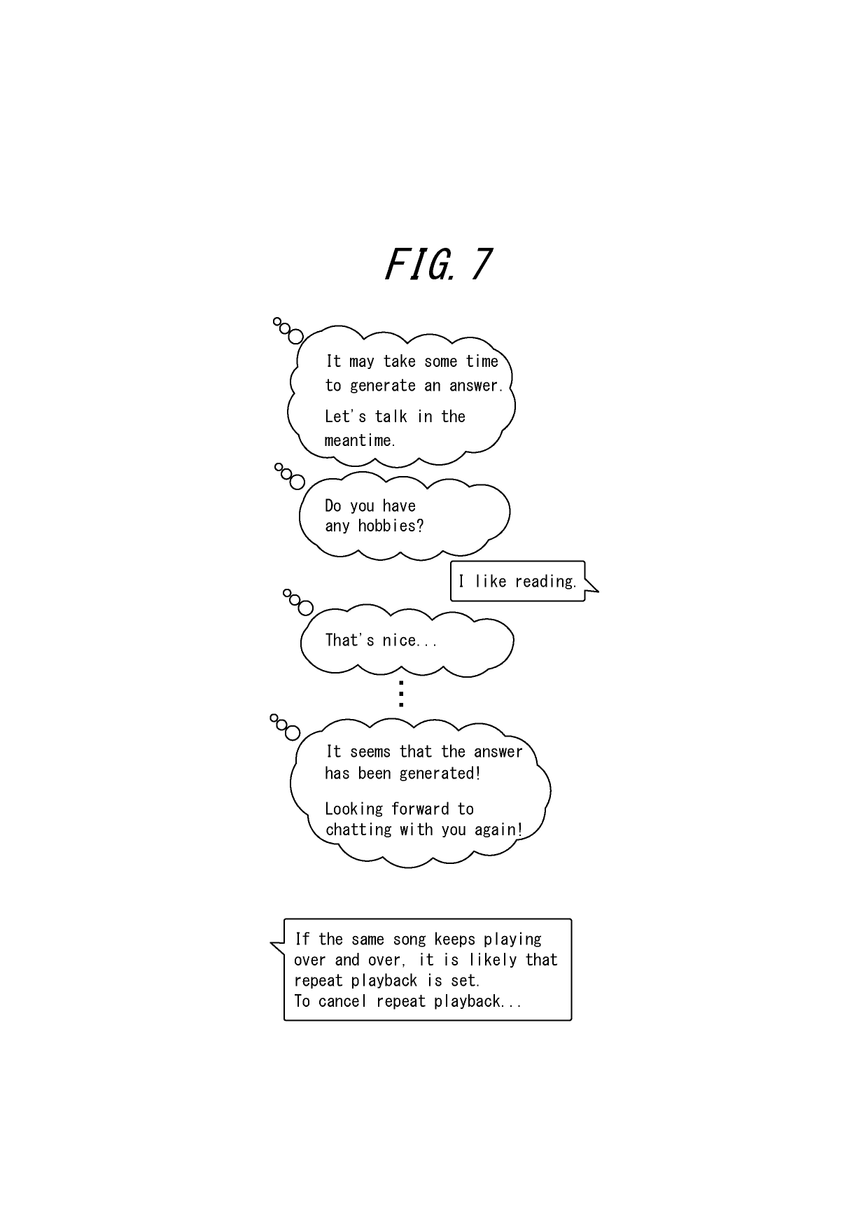

In the above embodiment, FIG. 7 illustrates an example of a screen in which dialogue with the first dialogue model and dialogue with the second dialogue model are displayed on the first screen 40 in a distinguishable manner for the user. In FIG. 7, the dialogue with the second dialogue model is displayed in cloud-shaped message boxes, the dialogue with the first dialogue model is displayed in a rectangular message box commented from the left, and question text from the user is displayed in a rectangular message box commented from the right. The method of displaying in a distinguishable manner includes varying the shapes or colors of the message boxes, varying the sizes, fonts, or colors of text, or changing the endings of sentences, but any method not limited to these can be employed. This allows the user to instantly grasp which dialogue model, the first dialogue model or the second dialogue mode, the user is performing dialogue with. The user can also recognize that the system 1 is operating normally.

In the above embodiment, the server 20 may transmit, to the communication apparatus 10, a message indicating that the first dialogue model is about to complete or has completed generating an answer during performing dialogue between the user and the second dialogue model, at the time of completing generating the answer by the first dialogue model. The communication apparatus 10 may also display, on the output interface 12, the message received from the server 20. For example, in FIG. 7, a message "It seems that an answer has been generated! Looking forward to chatting with you again!" is displayed using a message box for the second dialogue model. The message may be displayed using a message box for the second dialogue model, but any method such as displaying a standard phrase can be employed. As the method indicating that the first dialogue model is about to complete or has completed generating an answer, any method such as displaying a message, audio output, or vibration can be employed. This allows the user to move to a safe place and check the answer upon completion of answer generation, even when, for example, the user cannot concentrate on the answer due to driving of a vehicle. Therefore, the user can spend the waiting time until the generation of the answer is completed meaningfully.

In the above embodiment, the server 20 may share the context of the dialogue between the user and the first dialogue model with the second dialogue model. A method of sharing the context may include, for example, the controller 24 inputting information extracted from the question text of the user into the second dialogue model, but any method not limited to this can be employed. Sharing the context of the first dialogue model allows the second dialogue model to provide topics of interest to the user. It is also possible to provide beneficial information to the user. This makes it possible to reduce the perceived time of the user. This can engage in dialogue on topics of interest to the user, and therefore enhance the satisfaction of the user with the system 1.

For example, an embodiment in which a general purpose computer functions as the server 20 according to the above embodiment can also be implemented. Specifically, a program in which processes for realizing the functions of the server 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

### Appendix 1 A system comprising:

a communication apparatus; and

a server,

wherein

the server is configured to store a first dialogue model and a second dialogue model,

the communication apparatus is configured to:

display a first screen on which dialogue between a user and the first dialogue model is performed; and

transmit, to the server, question text inputted on the first screen by the user, and

the server is configured to:

determine whether predicted time required for the first dialogue model to generate an answer to a question content according to the question text is long relative to a predetermined reference; and

when the predicted time is determined to be long relative to the predetermined reference, perform dialogue between the user and the second dialogue model until the first dialogue model completes generating the answer.

### Appendix 2 The system according to appendix 1, wherein the server is configured to:

store historical information including one or more past inputted question contents and one or more answer contents to the one or more question contents;

when the question content according to the question text inputted by the user is included in the historical information, determine that the predicted time is short, extract, using the first dialogue model, an answer content corresponding to the question content from the historical information, and generate an answer to the question content based on the extracted answer content; and

when the question content according to the question text inputted by the user is not included in the historical information, determine that the predicted time is long, and generate an answer to the question content using the first dialogue model.

### Appendix 3 The system according to appendix 1 or 2, wherein the server is configured to:

store a database containing materials regarding vehicles;

determine whether it is necessary for the first dialogue model to refer to the database in order to generate an answer to the question content according to the question text inputted by the user;

when it is determined that the first dialogue model does not need to refer to the database, determine that the predicted time is short, and generate an answer to the question content using the first dialogue model; and

when it is determined that the first dialogue model needs to refer to the database, determine that the predicted time is long, and generate, using the first dialogue model, an answer to the question content with reference to the database.

Appendix 4 The system according to any one of appendices 1 to 3, wherein when dialogue between the user and the second dialogue model is performed, the communication apparatus is configured to overlay, on the first screen, a second screen to perform the dialogue with the second dialogue model.

Appendix 5 The system according to any one of appendices 1 to 4, wherein

the server is configured to transmit, to the communication apparatus, the question content according to the question text inputted by the user, and

the communication apparatus is configured to display the question content until acquiring an answer to the question content from the server.

Appendix 6 The system according to any one of appendices 1 to 3 or 5, wherein when dialogue between the user and the second dialogue model is performed, the communication apparatus is configured to display, on the first screen, the dialogue with the first dialogue model and the dialogue with the second dialogue model in a distinguishable manner for the user.

Appendix 7 The system according to any one of appendices 1 to 6, wherein

the server is configured to transmit, to the communication apparatus, a message indicating that the first dialogue model is about to complete or has completed generating an answer during performing dialogue between the user and the second dialogue model, at the time of completing generating the answer by the first dialogue model, and

the communication apparatus is configured to display the received message.

Appendix 8 A method performed by a system including a communication apparatus and a server, the method comprising:

storing, by the server, a first dialogue model and a second dialogue model;

displaying, by the communication apparatus, a first screen on which dialogue between a user and the first dialogue model is performed;

transmitting, by the communication apparatus to the server, question text inputted on the first screen by the user;

determining, by the server, whether predicted time required for the first dialogue model to generate an answer to a question content according to the question text is long relative to a predetermined reference; and

when the predicted time is determined to be long relative to the predetermined reference, performing, by the server, dialogue between the user and the second dialogue model until the first dialogue model completes generating the answer.

Appendix 9 The method according to appendix 8, further comprising storing, by the server, historical information including one or more past inputted question contents and one or more answer contents to the one or more question contents,

wherein

when the question content according to the question text inputted by the user is included in the historical information, the server is configured to determine that the predicted time is short, extract, using the first dialogue model, an answer content corresponding to the question content from the historical information, and generate an answer to the question content based on the extracted answer content, and

when the question content according to the question text inputted by the user is not included in the historical information, the server is configured to determine that the predicted time is long, and generate, using the first dialogue model, an answer to the question content.

### Appendix 10 The method according to appendix 8 or 9, further comprising:

storing, by the server, a database containing materials regarding vehicles; and

determining, by the server, whether it is necessary for the first dialogue model to refer to the database in order to generate an answer to the question content according to the question text inputted by the user,

wherein

when it is determined that the first dialogue model does not need to refer to the database, the server is configured to determine that the predicted time is short, and generate, using the first dialogue model, an answer to the question content, and

when it is determined that the first dialogue model needs to refer to the database, the server is configured to determine that the predicted time is long, and generate, using the first dialogue model, an answer to the question content with reference to the database.

Appendix 11 The method according to any one of appendices 8 to 10, further comprising, when dialogue between the user and the second dialogue model is performed, overlaying, by the communication apparatus on the first screen, a second screen to perform the dialogue with the second dialogue model.

### Appendix 12 The method according to any one of appendices 8 to 11, further comprising:

transmitting, by the server to the communication apparatus, the question content according to the question text inputted by the user; and

displaying, by the communication apparatus, the question content until acquiring an answer to the question content from the server.

Appendix 13 The method according to any one of appendices 8 to 10 or 12, wherein when dialogue between the user and the second dialogue model is performed, the communication apparatus is configured to display, on the first screen, the dialogue with the first dialogue model and the dialogue with the second dialogue model in a distinguishable manner for the user.

### Appendix 14 The method according to any one of appendices 8 to 13, further comprising:

transmitting, by the server to the communication apparatus, a message indicating that the first dialogue model is about to complete or has completed generating an answer during performing dialogue between the user and the second dialogue model, at the time of completing generating the answer by the first dialogue model; and

displaying, by the communication apparatus, the received message.

### Appendix 15 A program configured to cause a system including a communication apparatus and a server to execute operations, the operations comprising:

storing, by the server, a first dialogue model and a second dialogue model;

displaying, by the communication apparatus, a first screen on which dialogue between a user and the first dialogue model is performed;

transmitting, by the communication apparatus to the server, question text inputted on the first screen by the user;

determining, by the server, whether predicted time required for the first dialogue model to generate an answer to a question content according to the question text is long relative to a predetermined reference; and

when the predicted time is determined to be long relative to the predetermined reference, performing, by the server, dialogue between the user and the second dialogue model until the first dialogue model completes generating the answer.

Appendix 16 The program according to appendix 15, wherein

the operations further comprise storing, by the server, historical information including one or more past inputted question contents and one or more answer contents to the one or more question contents,

when the question content according to the question text inputted by the user is included in the historical information, the server is configured to determine that the predicted time is short, extract, using the first dialogue model, an answer content corresponding to the question content from the historical information, and generate an answer to the question content based on the extracted answer content, and

when the question content according to the question text inputted by the user is not included in the historical information, the server is configured to determine that the predicted time is long, and generate, using the first dialogue model, an answer to the question content.

### Appendix 17 The program according to appendix 15 or 16, wherein the operations comprise:

storing, by the server, a database containing materials regarding vehicles; and

determining, by the server, whether it is necessary for the first dialogue model to refer to the database in order to generate an answer to the question content according to the question text inputted by the user,

wherein

when it is determined that the first dialogue model does not need to refer to the database, the server is configured to determine that the predicted time is short, and generate, using the first dialogue model, an answer to the question content, and

when it is determined that the first dialogue model needs to refer to the database, the server is configured to determine that the predicted time is long, and generate, using the first dialogue model, an answer to the question content with reference to the database.

Appendix 18 The program according to any one of appendices 15 to 17, wherein the operations comprise, when dialogue between the user and the second dialogue model is performed, overlaying, by the communication apparatus on the first screen, a second screen to perform the dialogue with the second dialogue model.

### Appendix 19 The program according to any one of appendices 15 to 17, wherein the operations further comprise:

transmitting, by the server to the communication apparatus, the question content according to the question text inputted by the user; and

displaying, by the communication apparatus, the question content until acquiring an answer to the question content from the server,

wherein when dialogue between the user and the second dialogue model is performed, the communication apparatus is configured to display, on the first screen, the dialogue with the first dialogue model and the dialogue with the second dialogue model in a distinguishable manner for the user.

### Appendix 20 The program according to any one of appendices 15 to 19, wherein the operations further comprise:

transmitting, by the server to the communication apparatus, a message indicating that the first dialogue model is about to complete or has completed generating an answer during performing dialogue between the user and the second dialogue model, at the time of completing generating the answer by the first dialogue model; and

displaying, by the communication apparatus, the received message.

1. A system comprising:
a communication apparatus; and
a server,
wherein
the server is configured to store a first dialogue model and a second dialogue model,
the communication apparatus is configured to:
display a first screen on which dialogue between a user and the first dialogue model is performed; and
transmit, to the server, question text inputted on the first screen by the user, and
the server is configured to:
determine whether predicted time required for the first dialogue model to generate an answer to a question content according to the question text is long relative to a predetermined reference; and
when the predicted time is determined to be long relative to the predetermined reference, perform dialogue between the user and the second dialogue model until the first dialogue model completes generating the answer.

2. The system according to claim 1, wherein the server is configured to:
store historical information including one or more past inputted question contents and one or more answer contents to the one or more question contents;
when the question content according to the question text inputted by the user is included in the historical information, determine that the predicted time is short, extract, using the first dialogue model, an answer content corresponding to the question content from the historical information, and generate an answer to the question content based on the extracted answer content; and
when the question content according to the question text inputted by the user is not included in the historical information, determine that the predicted time is long, and generate an answer to the question content using the first dialogue model.

3. The system according to claim 1, wherein the server is configured to:
store a database containing materials regarding vehicles;
determine whether it is necessary for the first dialogue model to refer to the database in order to generate an answer to the question content according to the question text inputted by the user;
when it is determined that the first dialogue model does not need to refer to the database, determine that the predicted time is short, and generate an answer to the question content using the first dialogue model; and
when it is determined that the first dialogue model needs to refer to the database, determine that the predicted time is long, and generate, using the first dialogue model, an answer to the question content with reference to the database.

4. The system according to claim 1, wherein when dialogue between the user and the second dialogue model is performed, the communication apparatus is configured to overlay, on the first screen, a second screen to perform the dialogue with the second dialogue model.

5. The system according to claim 1, wherein
the server is configured to transmit, to the communication apparatus, the question content according to the question text inputted by the user, and
the communication apparatus is configured to display the question content until acquiring an answer to the question content from the server.

6. The system according to claim 1, wherein when dialogue between the user and the second dialogue model is performed, the communication apparatus is configured to display, on the first screen, the dialogue with the first dialogue model and the dialogue with the second dialogue model in a distinguishable manner for the user.

7. The system according to claim 1, wherein
the server is configured to transmit, to the communication apparatus, a message indicating that the first dialogue model is about to complete or has completed generating an answer during performing dialogue between the user and the second dialogue model, at time of completing generating the answer by the first dialogue model, and
the communication apparatus is configured to display the received message.

8. A method performed by a system including a communication apparatus and a server, the method comprising:
storing, by the server, a first dialogue model and a second dialogue model;
displaying, by the communication apparatus, a first screen on which dialogue between a user and the first dialogue model is performed;
transmitting, by the communication apparatus to the server, question text inputted on the first screen by the user;
determining, by the server, whether predicted time required for the first dialogue model to generate an answer to a question content according to the question text is long relative to a predetermined reference; and
when the predicted time is determined to be long relative to the predetermined reference, performing, by the server, dialogue between the user and the second dialogue model until the first dialogue model completes generating the answer.

9. The method according to claim 8, further comprising storing, by the server, historical information including one or more past inputted question contents and one or more answer contents to the one or more question contents,
wherein
when the question content according to the question text inputted by the user is included in the historical information, the server is configured to determine that the predicted time is short, extract, using the first dialogue model, an answer content corresponding to the question content from the historical information, and generate an answer to the question content based on the extracted answer content, and
when the question content according to the question text inputted by the user is not included in the historical information, the server is configured to determine that the predicted time is long, and generate, using the first dialogue model, an answer to the question content.

10. The method according to claim 8, further comprising:
storing, by the server, a database containing materials regarding vehicles; and
determining, by the server, whether it is necessary for the first dialogue model to refer to the database in order to generate an answer to the question content according to the question text inputted by the user,
wherein
when it is determined that the first dialogue model does not need to refer to the database, the server is configured to determine that the predicted time is short, and generate, using the first dialogue model, an answer to the question content, and
when it is determined that the first dialogue model needs to refer to the database, the server is configured to determine that the predicted time is long, and generate, using the first dialogue model, an answer to the question content with reference to the database.

11. The method according to claim 8, further comprising, when dialogue between the user and the second dialogue model is performed, overlaying, by the communication apparatus on the first screen, a second screen to perform the dialogue with the second dialogue model.

12. The method according to claim 8, further comprising:
transmitting, by the server to the communication apparatus, the question content according to the question text inputted by the user; and
displaying, by the communication apparatus, the question content until acquiring an answer to the question content from the server.

13. The method according to claim 8, wherein when dialogue between the user and the second dialogue model is performed, the communication apparatus is configured to display, on the first screen, the dialogue with the first dialogue model and the dialogue with the second dialogue model in a distinguishable manner for the user.

14. The method according to claim 8, further comprising:
transmitting, by the server to the communication apparatus, a message indicating that the first dialogue model is about to complete or has completed generating an answer during performing dialogue between the user and the second dialogue model, at time of completing generating the answer by the first dialogue model; and
displaying, by the communication apparatus, the received message.

15. A non-transitory computer readable medium storing a program configured to cause a system including a communication apparatus and a server to execute operations, the operations comprising:
storing, by the server, a first dialogue model and a second dialogue model;
displaying, by the communication apparatus, a first screen on which dialogue between a user and the first dialogue model is performed;
transmitting, by the communication apparatus to the server, question text inputted on the first screen by the user;
determining, by the server, whether predicted time required for the first dialogue model to generate an answer to a question content according to the question text is long relative to a predetermined reference; and
when the predicted time is determined to be long relative to the predetermined reference, performing, by the server, dialogue between the user and the second dialogue model until the first dialogue model completes generating the answer.

16. The non-transitory computer readable medium according to claim 15, wherein
the operations further comprise storing, by the server, historical information including one or more past inputted question contents and one or more answer contents to the one or more question contents,
when the question content according to the question text inputted by the user is included in the historical information, the server is configured to determine that the predicted time is short, extract, using the first dialogue model, an answer content corresponding to the question content from the historical information, and generate an answer to the question content based on the extracted answer content, and
when the question content according to the question text inputted by the user is not included in the historical information, the server is configured to determine that the predicted time is long, and generate, using the first dialogue model, an answer to the question content.

17. The non-transitory computer readable medium according to claim 15, wherein the operations comprise:
storing, by the server, a database containing materials regarding vehicles; and
determining, by the server, whether it is necessary for the first dialogue model to refer to the database in order to generate an answer to the question content according to the question text inputted by the user,
wherein
when it is determined that the first dialogue model does not need to refer to the database, the server is configured to determine that the predicted time is short, and generate, using the first dialogue model, an answer to the question content, and
when it is determined that the first dialogue model needs to refer to the database, the server is configured to determine that the predicted time is long, and generate, using the first dialogue model, an answer to the question content with reference to the database.

18. The non-transitory computer readable medium according to claim 15, wherein the operations comprise, when dialogue between the user and the second dialogue model is performed, overlaying, by the communication apparatus on the first screen, a second screen to perform the dialogue with the second dialogue model.

19. The non-transitory computer readable medium according to claim 15, wherein the operations further comprise:
transmitting, by the server to the communication apparatus, the question content according to the question text inputted by the user; and
displaying, by the communication apparatus, the question content until acquiring an answer to the question content from the server,
wherein when dialogue between the user and the second dialogue model is performed, the communication apparatus is configured to display, on the first screen, the dialogue with the first dialogue model and the dialogue with the second dialogue model in a distinguishable manner for the user.

20. The non-transitory computer readable medium according to claim 15, wherein the operations further comprise:
transmitting, by the server to the communication apparatus, a message indicating that the first dialogue model is about to complete or has completed generating an answer during performing dialogue between the user and the second dialogue model, at time of completing generating the answer by the first dialogue model; and
displaying, by the communication apparatus, the received message.
